(19) United States
(12) Patent Application Publication
(10) Pub. No.: US 2016/0266585 A1
(43) Pub. Date: Sep. 15, 2016

(54) PRESSURE REGULATING VALVE

(71) Applicants: AISAN KOGYO KABUSHIKI KAISHA, Obu-shi, Aichi-ken (JP); TOYOTA JIDOSHA KABUSHIKI KAISHA, Toyota-shi, Aichi-ken (JP)

(72) Inventor: Hideyuki FUKUDA, Nagoya-shi (JP)

(73) Assignees: AISAN KOGYO KABUSHIKI KAISHA, Obu-shi, Aichi-ken (JP); TOYOTA JIDOSHA KABUSHIKI KAISHA, Toyota-shi, Aichi-ken (JP)

(21) Appl. No.: 15/031,914

(22) PCT Filed: Nov. 27, 2014
(86) PCT No.: PCT/JP2014/081428

§ 371 Date: Apr. 25, 2016

(30) Foreign Application Priority Data
Nov. 28, 2013 (JP) 2013-246595

(51) Int. Cl. G05D 16/10; F16K 27/12; F02M 37/00; F16K 24/00

(52) U.S. Cl. CPC G05D 16/106; F16K 24/00; F16K 27/12; F02M 37/0029

(57) ABSTRACT

A pressure-regulating valve includes a body and a valve member. The valve member divides an inner side of the body into a pressure regulation chamber and an atmospheric pressure chamber, which is in communication with the atmosphere. The valve member is configured so that pressure of the pressure regulation chamber moves the valve member in a direction that changes a volume of the pressure regulation chamber. The pressure-regulating valve includes a cap that covers a portion of the body where the atmospheric pressure chamber is in communication with the atmosphere and a communication portion having a labyrinth structure and located between an inner surface of the cap and an outer surface of the body opposing the inner surface. The atmospheric pressure chamber is in communication with the atmosphere through the communication portion.

### TECHNICAL FIELD

The present invention relates to a pressure-regulating valve.

### BACKGROUND ART

A fuel supply system for an internal combustion engine that uses gaseous fuel includes a pressure-regulating valve that decompresses high-pressure fuel stored in a fuel tank. The decompressed fuel is supplied to a fuel injection valve of the internal combustion engine.

Patent Document 1 describes an example of the pressure-regulating valve that includes a body and a valve member, which divides the inner side of the body into a pressure regulation chamber and an atmospheric pressure chamber. The pressure regulation chamber is in communication with a high-pressure passage, which is connected to the fuel tank, and a low-pressure passage, which is connected to the fuel injection valve. The atmospheric pressure chamber is in communication with the atmosphere. The pressure of the pressure regulation chamber moves the valve member in a direction that changes the volume of the pressure regulation chamber.

More specifically, when the injection of fuel from the fuel injection valve decreases the pressure of the pressure regulation chamber, the valve member moves in a direction that decreases the volume of the pressure regulation chamber. Such movement of the valve member connects the pressure regulation chamber to the high-pressure passage. This supplies fuel from the fuel tank through the high-pressure passage to the pressure regulation chamber. The fuel supplied from the fuel tank through the high-pressure passage to the pressure regulation chamber is decompressed, and the pressure of the pressure regulation chamber supplied with the fuel is increased.

When the pressure of the pressure regulation chamber increases, the valve moves in a direction that increases the volume of the pressure regulation chamber. Such movement of the valve member disconnects the pressure regulation chamber from the high-pressure passage. The decompressed fuel is supplied from the pressure regulation chamber through the low-pressure passage to the fuel injection valve of the internal combustion engine. Thus, the fuel injection valve is supplied with the high-pressure fuel stored in the fuel tank that has been decompressed in the pressure regulation chamber.

### PRIOR ART DOCUMENT

### Patent Document

Patent Document 1: Japanese Laid-Open Patent Publication No. 2008-282192

### SUMMARY OF THE INVENTION

### Problems that are to be Solved by the Invention

Movement of the valve member of the pressure-regulating valve in the direction that changes the volume of the pressure regulation chamber changes the volume of the atmospheric pressure chamber in accordance with the movement. Thus, air has to flow between the atmospheric pressure chamber and the outside (atmosphere) of the pressure-regulating valve to readily change the volume of the atmospheric pressure chamber, that is, to readily move the valve member. However, when the force of air drawn from the outside into the atmospheric pressure chamber is excessively strong, foreign matter and water may enter the atmospheric pressure chamber with the air. As a result, the pressure-regulating valve may fail to function properly.

Such a problem is not limited to a pressure-regulating valve used in a fuel supply system for an internal combustion engine and also applies to a pressure-regulating valve that decompresses fuel at a location other than where the fuel supply system for the internal combustion engine is arranged.

It is an object of the present invention to provide a pressure-regulating valve that restricts the entrance of foreign matter and water from the outside into the atmospheric pressure chamber while allowing air to flow properly between the atmospheric pressure chamber and the outside.

### Means for Solving the Problems

A pressure-regulating valve according to one aspect of the present invention includes a body and a valve member. The valve member divides an inner side of the body into a pressure regulation chamber, which is connected to a low-pressure passage and a high-pressure passage, and an atmospheric pressure chamber, which is in communication with the atmosphere. The valve member is configured so that pressure of the pressure regulation chamber moves the valve member in a direction that changes a volume of the pressure regulation chamber, a decrease in the pressure of the pressure regulation chamber moves the valve member in a direction that decreases the volume of the pressure regulation chamber and connects the pressure regulation chamber to the high-pressure passage, and an increase in the pressure of the pressure regulation chamber moves the valve member in a direction that increases the volume of the pressure regulation chamber and disconnects the pressure regulation chamber from the high-pressure passage. The pressure-regulating valve includes a cap that covers a portion of the body where the atmospheric pressure chamber is in communication with the atmosphere and a communication portion having a labyrinth structure and located between an inner surface of the cap and an outer surface of the body opposing the inner surface. The atmospheric pressure chamber is in communication with the atmosphere through the communication portion.

### BRIEF DESCRIPTION OF THE DRAWINGS

FIG. 1 is a cross-sectional view showing the structure of one embodiment of a pressure-regulating valve.

FIG. 2 is a cross-sectional view showing the structure of a cap of the pressure-regulating valve of FIG. 1 taken along line 2-2 in FIG. 3 in the direction of arrow 2.

FIG. 3 is a plan view showing the cap of the pressure-regulating valve of FIG. 1.

FIG. 4 is a bottom view showing the cap of the pressure-regulating valve of FIG. 1.

FIG. 5 is a view showing the cross section of the cap taken along line 5-5 in FIG. 2 in the direction of arrow 5.

FIG. 6 is a view showing the cross section of the cap taken along line 6-6 in FIG. 3 in the direction of arrow 6.

FIG. 7 is a view showing the cross section of the cap taken along line 7-7 in FIG. 3 in the direction of arrow 7.

FIG. 8 is a view showing the cross section of the cap taken along line 8-8 in FIG. 3 in the direction of arrow 8.

### EMBODIMENTS OF THE INVENTION

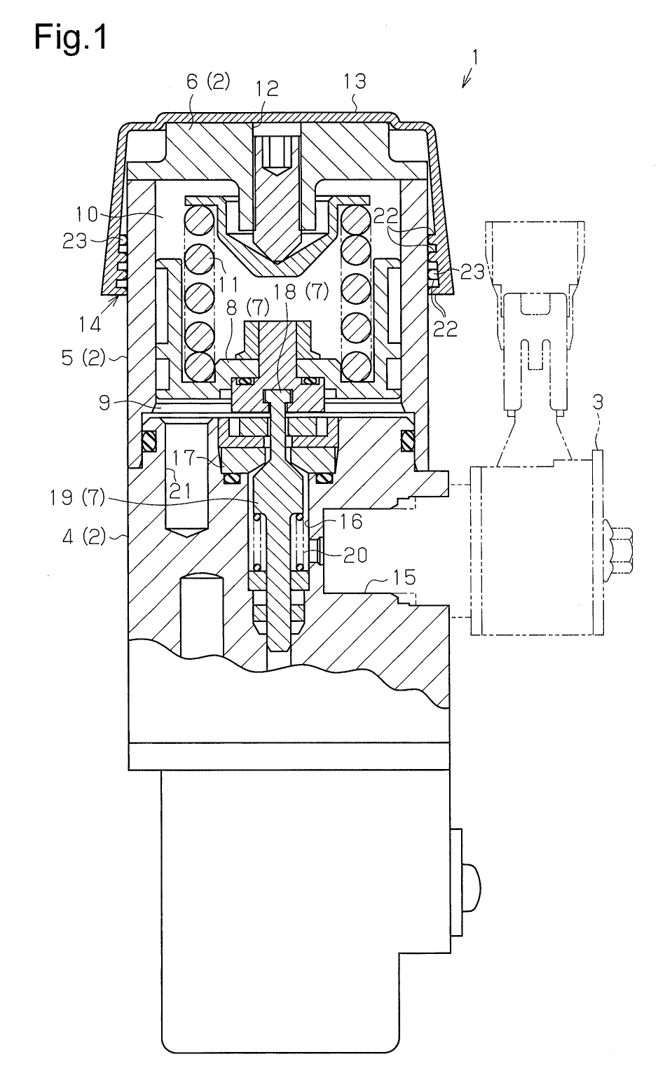

One embodiment of a pressure-regulating valve will now be described with reference to FIGS. 1 to 8.

A pressure-regulating valve 1 of FIG. 1 is arranged in a fuel supply system for an internal combustion engine that uses gaseous fuel. The pressure-regulating valve 1 includes a body 2 and a valve member 7, which is arranged inside the body 2. The body 2 includes a body block 4, to which a shutoff valve 3 is fixed, a cylinder 5, and a lid 6. One end of the cylinder 5 is fixed to the body block 4, and the lid 6 is attached to the other end of the cylinder 5. The valve member 7 includes a piston 8. The piston 8 divides the inner side of the body 2, that is, the portion surrounded by the body block 4, the cylinder 5, and the lid 6, into a pressure regulation chamber 9 and an atmospheric pressure chamber 10. The pressure regulation chamber 9 is closer to the body block 4, and the atmospheric pressure chamber 10 is closer to the lid 6. The valve member 7 is movable in a direction that changes the volume of the pressure regulation chamber 9 (vertical direction in FIG. 1).

A spring 11, which biases the piston 8 (valve member 7) toward the pressure regulation chamber 9, is arranged in the atmospheric pressure chamber 10. A gap, which extends between the cylinder 5 and the lid 6, and a communication hole 12, which is arranged at the middle of the lid 6, allow air to flow between the atmospheric pressure chamber 10 and the outside (atmosphere). The pressure-regulating valve 1 includes a cap 13 that covers portions of the body 2 (more specifically, cylinder 5 and lid 6) where the atmospheric pressure chamber 10 is in communication with the atmosphere, that is, the communication hole 12 of the lid 6 and the gap between the cylinder 5 and the lid 6. Further, a communication portion 14 located between the inner surface of the cap 13 and the outer surface of the body 2 (cylinder 5) has a labyrinth structure through which the atmospheric pressure chamber 10 (specifically, communication hole 12 of lid 6 and gap between cylinder 5 and lid 6) and the atmosphere are in communication.

The body block 4 includes a high-pressure passage 15, which is connected to a fuel tank that stores gaseous fuel for the internal combustion engine. Further, the body block 4 includes a low-pressure passage 21, which is in communication with the pressure regulation chamber 9 and connected to a fuel injection valve of the internal combustion engine. The shutoff valve 3 is coupled to the high-pressure passage 15. The shutoff valve 3 opens and closes to connect and disconnect the high-pressure passage 15 and the fuel tank. In addition, the high-pressure passage 15 is connected to the pressure regulation chamber 9 through an accommodation chamber 16, which extends in the movement direction of the valve member 7. A seal 17 is arranged where the accommodation chamber 16 opens to the pressure regulation chamber 9. A rod 18, which projects through the seal 17 toward the accommodation chamber 16, is fixed to the center of the piston 8 of the valve member 7. A valve shaft 19, which has a larger diameter than the rod 18, is defined by the portion of the rod 18 that is located in the accommodation chamber 16. Further, the accommodation chamber 16 includes a spring 20, which biases the valve shaft 19 toward the seal 17.

The valve member 7 includes the piston 8 and the rod 18, which includes the valve shaft 19. The pressure of the pressure regulation chamber 9 moves the valve member 7 in a direction that changes the volume of the pressure regulation chamber 9. When the valve member 7 moves in a direction that increases the volume of the pressure regulation chamber 9, the valve shaft 19 is pressed against the seal 17. This disconnects the pressure regulation chamber 9 from the high-pressure passage 15 (specifically, accommodation chamber 16). When the valve member 7 moves in a direction that decreases the volume of the pressure regulation chamber 9, the valve shaft 19 is separated from the seal 17. This connects the pressure regulation chamber 9 to the high-pressure passage 15 (accommodation chamber 16). When the pressure regulation chamber 9 and the high-pressure passage 15 are connected to each other in such a manner and the shutoff valve 3 is open, high-pressure fuel is supplied from the fuel tank through the high-pressure passage 15 and the accommodation chamber 16 to the pressure regulation chamber 9. The fuel supplied to the pressure regulation chamber 9 in such a manner is decompressed and then supplied through the low-pressure passage 21 to the fuel injection valve of the internal combustion engine.

In the pressure-regulating valve 1, when the injection of fuel from the fuel injection valve during operation of the internal combustion engine decreases the pressure of the pressure regulation chamber 9 to less than a specified value, the valve member 7 moves in the direction that decreases the volume of the pressure regulation chamber 9. This separates the valve shaft 19 from the seal 17 and connects the pressure regulation chamber 9 to the high-pressure passage 15. In such a condition, when the shutoff valve 3 is open, high-pressure fuel is supplied from the fuel tank through the high-pressure passage 15 and the accommodation chamber 16 to the pressure regulation chamber 9. The fuel supplied to the pressure regulation chamber 9 in such a manner is decompressed, and the pressure of the pressure regulation chamber 9 supplied with the decompressed fuel is increased. When the pressure of the pressure regulation chamber 9 increases to greater than or equal to the specified value, the valve member 7 moves in the direction that increases the volume of the pressure regulation chamber 9. This presses the valve shaft 19 against the seal 17 and disconnects the pressure regulation chamber 9 from the high-pressure passage 15. The specified value may be set by changing the pressure receiving area of the piston 8 that receives pressure from the pressure regulation chamber 9, the elastic coefficient of the spring 11, and the elastic coefficient of the spring 20. Further, the specified value may be set by changing the load applied to the spring 11 when set and the load applied to the spring 20 when set.

The communication portion 14, which is located between the inner surface of the cap 13 and the outer surface of the body 2 (cylinder 5), will now be described.

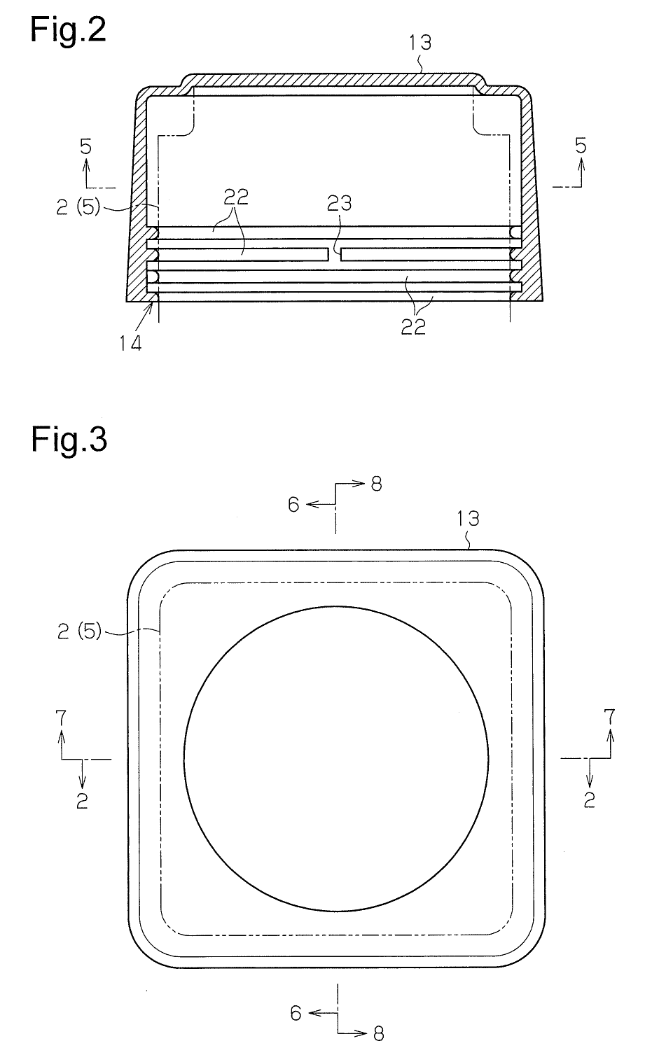

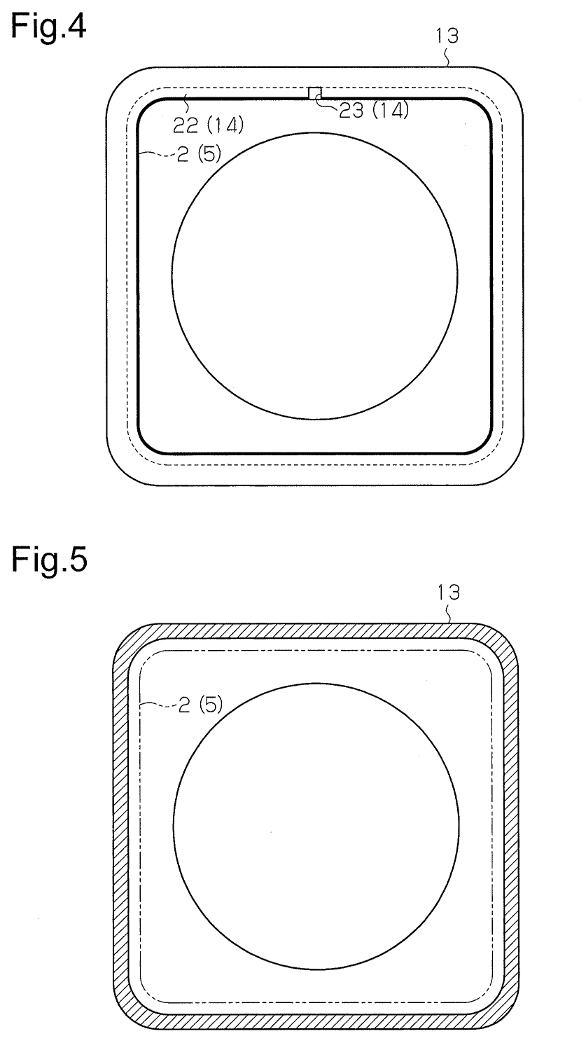

FIGS. 2 to 5 illustrate the form of the cap 13 in detail. FIG. 3 is a plan view showing the cap 13, and FIG. 4 is a bottom view showing the cap 13. FIG. 2 is a cross-sectional view of the cap 13 taken along line 2-2 in FIG. 3 in the direction of arrow 2, and FIG. 5 is a cross-sectional view of the cap 13 taken along line 5-5 in FIG. 2 in the direction of arrow 5.

As shown in FIG. 2, ribs 22 are arranged between the inner surface of the cap 13 and the outer surface of the body 2. The ribs 22 are projected from the inner surface of the cap 13 to contact the outer surface of the body 2 and arranged in the vertical direction in FIG. 2 (movement direction of valve member 7 in FIG. 1) at predetermined intervals. This example includes a total of four ribs 22. Each rib 22 extends continuously around the entire body 2. As shown in FIGS. 3 to 5, the outer surface of the body 2 and the inner surface of the cap 13, that is, the portions of the body 2 and the cap 13 corresponding to the ribs 22, are polygonal (tetragonal in this example) in a cross section taken in the direction the ribs 22 extend continuously around the body 2.

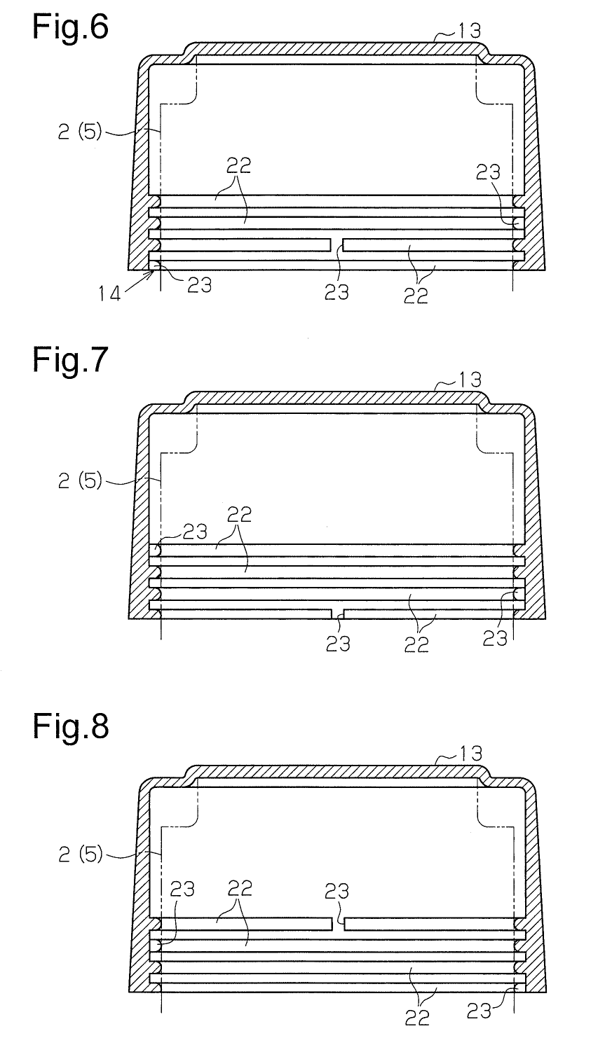

FIG. 6 is a cross-sectional view of the cap 13 taken along line 6-6 in FIG. 3 in the direction of arrow 6, FIG. 7 is a cross-sectional view of the cap 13 taken along line 7-7 in FIG. 3 in the direction of arrow 7, and FIG. 8 is a cross-sectional view of the cap 13 taken along line 8-8 in FIG. 3 in the direction of arrow 8. The ribs 22 shown in FIGS. 2 and 6 to 8 each include a slit 23. The slits 23 of adjacent ribs are located at different positions in the extension direction of the ribs 22. In addition, the slit 23 of each rib 22 is located at a different position. More specifically, the slit 23 of each rib 22 is located on a different side of the polygon (tetragon). The gap between the adjacent ribs 22 and the slit 23 of each rib 22 form the labyrinth-structure communication portion 14 between the inner surface of the cap 13 and the outer surface of the body 2 (cylinder 5). In other words, the labyrinth-structure communication portion 14 is formed by the ribs 22, which include the slits 23 and form gaps between the adjacent ones. The communication portion 14 allows the atmospheric pressure chamber 10 of FIG. 1 (specifically, communication hole 12 of lid 6 and gap between cylinder 5 and lid 6) to be in communication with the atmosphere.

The operation of the pressure-regulating valve 1 will now be described.

In the pressure-regulating valve 1, a decrease in the pressure of the pressure regulation chamber 9 to less than the specified value moves the valve member 7 (piston 8) in the direction that decreases the volume of the pressure regulation chamber 9. This connects the pressure regulation chamber 9 to the high-pressure passage 15. An increase in the pressure of the pressure regulation chamber 9 to greater than or equal to the specified value moves the valve member 7 in the direction that increases the volume of the pressure regulation chamber 9. This disconnects the pressure regulation chamber 9 from the high-pressure passage 15. When the valve member 7 moves in a direction that changes the volume of the pressure regulation chamber 9, the volume of the atmospheric pressure chamber 10 changes in accordance with the movement. Thus, air has to flow between the atmospheric pressure chamber 10 and the outside (atmosphere) to readily change the volume of the atmospheric pressure chamber 10, that is, to readily move the valve member 7.

The communication hole 12 of the lid 6 and the gap between the cylinder 5 and the lid 6 allow air to flow between the atmospheric pressure chamber 10 and the outside (atmosphere). Further, the cap 13 is arranged on the body 2 to cover the communication hole 12 of the lid 6 and the gap between the cylinder 5 and the lid 6. In addition, the communication portion 14, which allows the atmosphere to be in communication with the communication hole 12 of the lid 6 and the gap between the cylinder 5 and the lid 6, is located between the inner surface of the cap 13 and the outer surface of the body 2. The communication portion 14 and the like allow air to flow between the atmospheric pressure chamber 10 and the atmosphere. This readily changes the volume of the atmospheric pressure chamber 10, that is, readily moves the valve member 7.

However, when the force of air drawn from the outside (atmosphere) into the atmospheric pressure chamber 10 is excessively strong, foreign matter and water may enter the atmospheric pressure chamber 10 with the air. As a result, the pressure-regulating valve 1 may fail to function properly. To cope with such a situation, the communication portion 14, through which the atmospheric pressure chamber 10 is in communication with the outside, has the labyrinth structure.

More specifically, the ribs 22, which project from the inner surface of the cap 13 to contact the outer surface of the body 2, are extended continuously around the entire body 2 to be polygonal (tetragonal in this example) and arranged in the movement direction of the valve member 7. Further, the ribs 22 each include the slit 23. The slit 23 of each rib 22 is located at a different position in the extension direction of the ribs 22. That is, the slit 23 of each rib 22 is located at a different side of the polygon (tetragon). The ribs 22 and the slits 23 of the ribs 22 define the labyrinth structure of the communication portion 14.

Such a labyrinth structure of the communication portion 14, through which the atmospheric pressure chamber 10 is in communication with the outside, draws air along a smooth flow into the atmospheric pressure chamber 10 from the outside through the communication portion 14 when the valve member 7 moves (when the volume of the atmospheric pressure chamber 10 changes). This limits the entrance of foreign matter and water into the atmospheric pressure chamber 10 with the air. Further, situations are reduced in which the pressure-regulating valve 1 fails to function properly due to the entrance of foreign matter and water into the atmospheric pressure chamber 10.

The present embodiment has the advantages described below.

(1) The entrance of foreign matter and water from the outside into the atmospheric pressure chamber 10 is limited while allowing air to flow properly between the atmospheric pressure chamber 10 and the outside during movement of the valve member 7.

(2) Since the entrance of foreign matter and water into the atmospheric pressure chamber 10 is limited, situations are reduced in which the pressure-regulating valve 1 fails to function properly due to such a reason.

(3) The entrance of water into the atmospheric pressure chamber 10 is limited. This limits corrosion of the components of the pressure-regulating valve 1 arranged near the atmospheric pressure chamber 10 that would be caused by the entrance of water.

The present invention may be modified as follows.

The portions of the body 2 and the cap 13 corresponding to the ribs 22 have tetragonal cross sections in the direction the ribs 22 extend continuously around the body 2. Instead, the portions may have the form of a polygon other than a tetragon, for example, a pentagon, a hexagon, or an octagon.

The portions of the body 2 and the cap 13 corresponding to the ribs 22 do not have to be polygonal as described above. Instead, the portions may be circular or oval.

The number of the ribs 22 for obtaining the labyrinth structure of the communication portion 14 does not have to be four. Instead, the number of ribs 22 may differ from the number of corners of the above polygon.

The slit 23 of each rib 22 does not have to be located at a different position in the extension direction of the ribs 22. Instead, only the slits 23 of adjacent ribs 22 may be located at different positions.

A single rib 22 includes a single slit 23. Instead, a single rib 22 may include a plurality of slits 23.

The ribs 22 do not have to project from the inner surface of the cap 13. Instead, the ribs 22 may project from the outer surface of the body 2 (cylinder 5) and contact the inner surface of the cap 13.

The labyrinth structure of the communication portion 14 is obtained by the ribs 22 and the slit 23 of each rib 22. Instead, the labyrinth structure may be obtained by other structures.

The communication hole 12 may be located at a position separated from the center of the lid 6.

The communication hole 12 may be arranged in a side surface of the cylinder 5 instead of the lid 6.

The pressure-regulating valve 1 does not have to be arranged in a fuel supply system for an internal combustion engine. The pressure-regulating valve 1 may be arranged at a location where fuel is decompressed other than where a fuel supply system for an internal combustion engine is arranged.

1. A pressure-regulating valve comprising:
a body;
a valve member that divides an inner side of the body into a pressure regulation chamber, which is connected to a low-pressure passage and a high-pressure passage, and an atmospheric pressure chamber, which is in communication with the atmosphere, wherein the valve member is configured so that pressure of the pressure regulation chamber moves the valve member in a direction that changes a volume of the pressure regulation chamber, wherein a decrease in the pressure of the pressure regulation chamber moves the valve member in a direction that decreases the volume of the pressure regulation chamber and connects the pressure regulation chamber to the high-pressure passage, and an increase in the pressure of the pressure regulation chamber moves the valve member in a direction that increases the volume of the pressure regulation chamber and disconnects the pressure regulation chamber from the high-pressure passage;
a cap that covers a portion of the body where the atmospheric pressure chamber is in communication with the atmosphere; and
a communication portion having a labyrinth structure and located between an inner surface of the cap and an outer surface of the body opposing the inner surface, wherein the atmospheric pressure chamber is in communication with the atmosphere through the communication portion.

2. The pressure-regulating valve according to claim 1, further comprising ribs located between the inner surface of the cap and the outer surface of the body, wherein the ribs are extended continuously around the entire body, the ribs are arranged in a movement direction of the valve member, and a gap is formed between adjacent ones of the ribs, wherein
the ribs each include a slit, and the slits of adjacent ones of the ribs are located at different positions in an extension direction of the ribs to form the communication portion having the labyrinth structure.

3. The pressure-regulating valve according to claim 2, wherein the slit of each rib is located at a different position in the extension direction of the ribs.

4. The pressure-regulating valve according to claim 3, wherein portions of the body and the cap corresponding to the ribs are polygonal in a cross section taken in the extension direction of the ribs, wherein
the slit of each rib is located on a different side of the polygon.
